(19) United States
(12) Patent Application Publication
(10) Pub. No.: US 2017/0058153 A1
(43) Pub. Date: Mar. 2, 2017

(54) Continuous Extrusion Process to Prepare Hot Melt Adhesive Compositions

(71) Applicant: ExxonMobil Chemical Patents Inc., Baytown, TX (US)

(72) Inventors: Jurgen J.M. Schroeyers, Bierbeek (Opvelp) (BE); Jean-Roch H. Schauder, Wavre (BE); Yann Devorest, Waterloo (BE); Rudi Bernaerts, Vlaams Brabant (BE)

(21) Appl. No.: 15/204,619

(22) Filed: Jul. 7, 2016

Related U.S. Application Data
(60) Provisional application No. 62/212,082, filed on Aug. 31, 2015.

(30) Foreign Application Priority Data
Oct. 23, 2015 (EP) 15191167.4

(51) Int. Cl. C09J 123/14; B01F 7/08

(52) U.S. Cl. CPC C09J 123/14; B01F 7/081; B01F 2215/0062

(57) ABSTRACT

A method of preparing a hot melt adhesive composition, comprising (A) feeding a polymer blend into an extruder; wherein the polymer blend comprises (a) a first propylene-based polymer, wherein the first propylene-based polymer is a homopolymer of propylene or a copolymer of propylene and ethylene or a C₄-C₁₀ alpha-olefin; and (b) a second propylene-based polymer, wherein the second propylene-based polymer is a homopolymer of propylene or a copolymer of propylene and ethylene or a C₄-C₁₀ alpha-olefin; wherein the second propylene-based polymer is different than the first propylene-based polymer and wherein the polymer blend has a melt viscosity of 1,000 cP to 20,000 cP at 190° C.; (B) feeding one or more adhesive components, selected from at least one of a tackifier, wax, antioxidant, functionalized polyolefin, oil, and combinations thereof, into the extruder; and (C) recovering an extrudate from the extruder, wherein the extrudate is a hot melt adhesive composition.

### PRIORITY

This invention claims priority to and the benefit of U.S. patent application Ser. No. 62/212,082, filed Aug. 31, 2015, and European Patent Application No. 15191167.4 filed Oct. 23, 2015, both of which are herein incorporated by reference.

### FIELD OF INVENTION

The present invention relates to continuous extrusion processes and an apparatus for performing the same.

### BACKGROUND

A number of processes exist for producing and extruding hot melt adhesive (HMA) compositions. Conventional extrusion processes employ batch mixers, for example anchor mixers, turbo spheres, vertical mixers, or z-blades. These processes having a typical mixing time ranging from 3 to 20 hours, depending on the finished adhesive viscosity and raw material characteristics.

Continuous extrusion processing can be economically advantageous over batch extrusion for high-volume production. As opposed to extrusion using batch mixers, continuous extrusion processes allow for reduced turnaround time for the equipment to be emptied and cleaned if needed.

Continuous extrusion processes exist in the market. For instance, International Patent Publication Nos. WO2014/090628 and WO2012/013699 disclose an adhesive composition produced using an extruder to reduce the viscosity of otherwise high viscosity polymers for use in adhesives; U.S. Patent Publication No. 2013/0281625 discloses means of adding a tackifier to a polypropylene melt extruder; and International Patent Publication No. WO2011/005528 discloses a method of finishing a tacky hot melt pressure-sensitive adhesive for use in bag applications. However, they are designed to extrude medium to high viscosity assembly hot melt adhesives and/or used in the reactive processing of components.

Accordingly, there is a need for a continuous extrusion process useful for low viscosity hot melt adhesive compositions, where the adhesive has a viscosity at 175° C. at or below 100,000 cP.

### SUMMARY

The foregoing and/or other challenges are addressed by the methods and products disclosed herein.

In one aspect, a method of a hot melt adhesive composition is provided. The method comprises (A) feeding a polymer blend into an extruder; wherein the polymer blend comprises (a) a first propylene-based polymer, wherein the first propylene-based polymer is a homopolymer of propylene or a copolymer of propylene and ethylene or a C₄ to C₁₀ alpha-olefin; and (b) a second propylene-based polymer, wherein the second propylene-based polymer is a homopolymer of propylene or a copolymer of propylene and ethylene or a C₄ to C₁₀ alpha-olefin; wherein the second propylene-based polymer is different than the first propylene-based polymer and wherein the polymer blend has a melt viscosity of about 1,000 cP to about 30,000 cP at 190° C.; (B) feeding one or more adhesive components into the extruder; wherein the adhesive components is selected from at least one of a tackifier, wax, antioxidant, functionalized polyolefin, plasticizer, oil, and combinations thereof; and (C) recovering an extrudate from the extruder, wherein the extrudate is a hot melt adhesive composition.

These and other aspects of the present inventions are described in greater detail in the following detailed description and are illustrated in the accompanying drawing.

### DETAILED DESCRIPTION

### Polymer Blend Compositions

A solution polymerization process for preparing a polyolefin adhesive component is generally performed by a system that includes a first reactor, a second reactor in parallel with the first reactor, a liquid-phase separator, a devolatilizing vessel, and a pelletizer. The first reactor and second reactor may be, for example, continuous stirred-tank reactors.

The first reactor may receive a first monomer feed, a second monomer feed, and a catalyst feed. The first reactor may also receive feeds of a solvent and an activator. The solvent and/or the activator feed may be combined with any of the first monomer feed, the second monomer feed, or catalyst feed or the solvent and activator may be supplied to the reactor in separate feed streams. A first polymer is produced in the first reactor and is evacuated from the first reactor via a first product stream. The first product stream comprises the first polymer, solvent, and any unreacted monomer.

In any embodiment, the first monomer in the first monomer feed may be propylene and the second monomer in the second monomer feed may be ethylene or a C₄ to C₁₀ olefin. In any embodiment, the second monomer may be ethylene, butene, hexene, and octene. Generally, the choice of monomers and relative amounts of chosen monomers employed in the process depends on the desired properties of the first polymer and final polymer blend. For adhesive compositions, ethylene and hexene are particularly preferred comonomers for copolymerization with propylene. In any embodiment, the relative amounts of propylene and comonomer supplied to the first reactor may be designed to produce a polymer that is predominantly propylene, i.e., a polymer that is more than 50 mol % propylene. In another embodiment, the first reactor may produce a homopolymer of propylene.

The second reactor may receive a third monomer feed of a third monomer, a fourth monomer feed of a fourth monomer, and a catalyst feed of a second catalyst. The second reactor may also receive feeds of a solvent and activator. The solvent and/or the activator feed may be combined with any of the third monomer feed, the fourth monomer feed, or second catalyst feed, or the solvent and activator may be supplied to the reactor in separate feed streams. A second polymer is produced in the second reactor and is evacuated from the second reactor via a second product stream. The second product stream comprises the second polymer, solvent, and any unreacted monomer.

In any embodiment, the third monomer may be propylene and the fourth monomer may be ethylene or a C₄ to C₁₀ olefin. In any embodiment, the fourth monomer may be ethylene, butene, hexene, and octene. In any embodiment, the relative amounts of propylene and comonomer supplied to the second reactor may be designed to produce a polymer that is predominantly propylene, i.e., a polymer that is more than 50 mol % propylene. In another embodiment, the second reactor may produce a homopolymer of propylene.

Preferably, the second polymer is different than the first polymer. The difference may be measured, for example, by the comonomer content, heat of fusion, crystallinity, branching index, weight average molecular weight, and/or polydispersity of the two polymers. In any embodiment, the second polymer may comprise a different comonomer than the first polymer or one polymer may be a homopolymer of propylene and the other polymer may comprise a copolymer of propylene and ethylene or a C₄ to C₁₀ olefin. For example, the first polymer may comprise a propylene-ethylene copolymer and the second polymer may comprise a propylene-hexene copolymer. In any embodiment, the second polymer may have a different weight average molecular weight (Mw) than the first polymer and/or a different melt viscosity than the first polymer. Furthermore, in any embodiment, the second polymer may have a different crystallinity and/or heat of fusion than the first polymer. Specific examples of the types of polymers that may be combined to produce advantageous blends are described in greater detail herein.

It should be appreciated that any number of additional reactors may be employed to produce other polymers that may be integrated with (e.g., grafted) or blended with the first and second polymers. In any embodiment, a third reactor may produce a third polymer. The third reactor may be in parallel with the first reactor and second reactor or the third reactor may be in series with one of the first reactor and second reactor.

Further description of exemplary methods for polymerizing the polymers described herein may be found in U.S. Pat. No. 6,881,800, which is incorporated by reference herein.

The first product stream and second product stream may be combined to produce a blend stream. For example, the first product stream and second product stream may supply the first and second polymer to a mixing vessel, such as a mixing tank with an agitator.

The blend stream may be fed to a liquid-phase separation vessel to produce a polymer rich phase and a polymer lean phase. The polymer lean phase may comprise the solvent and be substantially free of polymer. At least a portion of the polymer lean phase may be evacuated from the liquid-phase separation vessel via a solvent recirculation stream. The solvent recirculation stream may further include unreacted monomer. At least a portion of the polymer rich phase may be evacuated from the liquid-phase separation vessel via a polymer rich stream.

In any embodiment, the liquid-phase separation vessel may operate on the principle of Lower Critical Solution Temperature (LCST) phase separation. This technique uses the thermodynamic principle of spinodal decomposition to generate two liquid phases; one substantially free of polymer and the other containing the dissolved polymer at a higher concentration than the single liquid feed to the liquid-phase separation vessel.

Employing a liquid-phase separation vessel that utilizes spinodal decomposition to achieve the formation of two liquid phases may be an effective method for separating solvent from multi-modal polymer blends, particularly in cases in which one of the polymers of the blend has a weight average molecular weight less than 100,000 g/mol, and even more particularly between 10,000 g/mol and 60,000 g/mol. The concentration of polymer in the polymer lean phase may be further reduced by catalyst selection. Catalysts of Formula I (described below), particularly dimethylsilyl bis(2-methyl-4-phenylindenyl) zirconium dichloride, dimethylsilyl bis(2-methyl-5-phenylindenyl) hafnium dichloride, dimethylsilyl bis(2-methyl-4-phenylindenyl) zirconium dimethyl, and dimethylsilyl bis(2-methyl-4-phenylindenyl) hafnium dimethyl were found to be a particularly effective catalysts for minimizing the concentration of polymer in the lean phase. Accordingly, in any embodiment, one, both, or all polymers may be produced using a catalyst of Formula I, particularly dimethylsilyl bis(2-methyl-4-phenylindenyl) zirconium dichloride, dimethylsilyl bis(2-methyl-4-phenylindenyl) hafnium dichloride, dimethylsilyl bis(2-methyl-4-phenylindenyl) zirconium dimethyl, and dimethylsilyl bis(2-methyl-4-phenylindenyl) hafnium dimethyl.

Upon exiting the liquid-phase separation vessel, the polymer rich stream may then be fed to a devolatilizing vessel for further polymer recovery. In any embodiment, the polymer rich stream may also be fed to a low pressure separator before being fed to the inlet of the devolatilizing vessel. While in the vessel, the polymer composition may be subjected to a vacuum in the vessel such that at least a portion of the solvent is removed from the polymer composition and the temperature of the polymer composition is reduced, thereby forming a second polymer composition comprising the multi-modal polymer blend and having a lower solvent content and a lower temperature than the polymer composition as the polymer composition is introduced into the vessel. The polymer composition may then be discharged from the outlet of the vessel via a discharge stream.

The cooled discharge stream may then be fed to a pelletizer where the multi-modal polymer blend is then discharged through a pelletization die as formed pellets.

Pelletization of the polymer may be performed by an underwater, hot face, strand, water ring, or other similar pelletizer. Preferably an underwater pelletizer is used, but other equivalent pelletizing units known to those skilled in the art may also be used. General techniques for underwater pelletizing are known to those of ordinary skill in the art. Anti-agglomeration aids, such as dusting powder, may be added during or after pelletization for specific polymers to prevent pellets from agglomerating during storage.

WO Publication No. 2013/134038, incorporated herein in its entirety, generally describes the method of preparing polyolefin adhesive components and compositions.

As described herein, the polymer blend comprises a first propylene-based polymer and a second propylene-based polymer. Preferred first and/or second propylene-based polymers of the polymer blend are semi-crystalline propylene-based polymers. In any embodiment, the polymers may have a relatively low molecular weight, preferably about 150,000 g/mol or less. In any embodiment, the polymer may comprise a comonomer selected from the group consisting of ethylene and linear or branched C₄ to C₂₀ olefins and diolefins. In any embodiment, the comonomer may be ethylene or a C₄ to C₁₀ olefin.

The term “polymer” as used herein includes, but is not limited to, homopolymers, copolymers, interpolymers, terpolymers, etc. and alloys and blends thereof. Further, as used herein, the term “copolymer” is meant to include polymers having two or more monomers, optionally with other monomers, and may refer to interpolymers, terpolymers, etc. The term “polymer” as used herein also includes impact, block, graft, random and alternating copolymers. The term “polymer” shall further include all possible geometrical configurations unless otherwise specifically stated. Such configurations may include isotactic, syndiotactic and random symmetries. The term “polymer blend” as used herein includes, but is not limited to a blend of one or more polymers prepared in solution or by physical blending, such as melt blending.

“Propylene-based” as used herein, is meant to include any polymer comprising propylene, either alone or in combination with one or more comonomers, in which propylene is the major component (i.e., greater than 50 mol % propylene).

In any embodiment, one or more polymers of the polymer blend may comprise one or more propylene-based polymers, which comprise propylene and from about 2 mol % to about 30 mol % of one or more comonomers selected from C₂ and C₄-C₁₀ α-olefins. In any embodiment, the α-olefin comonomer units may derive from ethylene, butene, pentene, hexene, 4-methyl-1-pentene, octene, or decene. The embodiments described below are discussed with reference to ethylene and hexene as the α-olefin comonomer, but the embodiments are equally applicable to other copolymers with other α-olefin comonomers. In this regard, the copolymers may simply be referred to as propylene-based polymers with reference to ethylene or hexene as the α-olefin.

In any embodiment, the one or more propylene-based polymers of the polymer blend may include at least about 5 mol %, at least about 6 mol %, at least about 7 mol %, or at least about 8 mol %, or at least about 10 mol %, or at least about 12 mol % ethylene-derived or hexene-derived units. In those or other embodiments, the copolymers of the propylene-based polymer may include up to about 30 mol %, or up to about 25 mol %, or up to about 22 mol %, or up to about 20 mol %, or up to about 19 mol %, or up to about 18 mol %, or up to about 17 mol % ethylene-derived or hexene-derived units, where the percentage by mole is based upon the total moles of the propylene-derived and a-olefin derived units. Stated another way, the propylene-based polymer may include at least about 70 mol %, or at least about 75 mol %, or at least about 80 mol %, or at least about 81 mol % propylene-derived units, or at least about 82 mol % propylene-derived units, or at least about 83 mol % propylene-derived units; and in these or other embodiments, the copolymers of the propylene-based polymer may include up to about 95 mol %, or up to about 94 mol %, or up to about 93 mol %, or up to about 92 mol %, or up to about 90 mol %, or up to about 88 mol % propylene-derived units, where the percentage by mole is based upon the total moles of the propylene-derived and alpha-olefin derived units. In any embodiment, the propylene-based polymer may comprise from about 5 mol % to about 25 mol % ethylene-derived or hexene-derived units, or from about 8 mol % to about 20 mol % ethylene-derived or hexene-derived units, or from about 12 mol % to about 18 mol % ethylene-derived or hexene-derived units.

The one or more polymers of the blend of one or more embodiments are characterized by a melting point (Tm), which can be determined by differential scanning calorimetry (DSC). For purposes herein, the maximum of the highest temperature peak is considered to be the melting point of the polymer. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak.

In any embodiment, the Tm of the one or more polymers of the blend (as determined by DSC) may be less than about 130° C., or less than about 125° C., less than about 120° C., or less than about 115° C., or less than about 110° C., or less than about 100° C., or less than about 90° C., and greater than about 70° C., or greater than about 75° C., or greater than about 80° C., or greater than about 85° C. In any embodiment, the Tm of the one or more polymers of the blend may be greater than about 25° C., or greater than about 30° C., or greater than about 35° C., or greater than about 40° C. Tm of the polymer blend can be determined by taking 5 to 10 mg of a sample of the polymer blend, equilibrating a DSC Standard Cell FC at −90° C., ramping the temperature at a rate of 10° C. per minute up to 200° C., maintaining the temperature for 5 minutes, lowering the temperature at a rate of 10° C. per minute to −90° C., ramping the temperature at a rate of 10° C. per minute up to 200° C., maintaining the temperature for 5 minutes, and recording the temperature as Tm.

In one or more embodiments, the crystallization temperature (Tc) of the one or more polymers of the polymer blend (as determined by DSC) is less than about 100° C., or less than about 90° C., or less than about 80° C., or less than about 70° C., or less than about 60° C., or less than about 50° C., or less than about 40° C., or less than about 30° C., or less than about 20° C., or less than about 10° C. In the same or other embodiments, the Tc of the polymer is greater than about 0° C., or greater than about 5° C., or greater than about 10° C., or greater than about 15° C., or greater than about 20° C. In any embodiment, the Tc lower limit of the polymer may be 0° C., 5° C., 10° C., 20° C., 30° C., 40° C., 50° C., 60° C., and 70° C.; and the Tc upper limit temperature may be 120° C., 110° C., 100° C., 90° C., 80° C., 70° C., 60° C., 50° C., 40° C., 30° C., 25° C., and 20° C. with ranges from any lower limit to any upper limit being contemplated. Tc of the polymer blend can be determined by taking 5 to 10 mg of a sample of the polymer blend, equilibrating a DSC Standard Cell FC at −90° C., ramping the temperature at a rate of 10° C. per minute up to 200° C., maintaining the temperature for 5 minutes, lowering the temperature at a rate of 10° C. per minute to −90° C., and recording the temperature as Tc.

The polymers suitable for use herein are said to be “semi-crystalline”, meaning that in general they have a relatively low crystallinity. The term “crystalline” as used herein broadly characterizes those polymers that possess a high degree of both inter and intra molecular order, and which preferably melt higher than 110° C., more preferably higher than 115° C., and most preferably above 130° C. A polymer possessing a high inter and intra molecular order is said to have a “high” level of crystallinity, while a polymer possessing a low inter and intra molecular order is said to have a “low” level of crystallinity. Crystallinity of a polymer can be expressed quantitatively, e.g., in terms of percent crystallinity, usually with respect to some reference or benchmark crystallinity. As used herein, crystallinity is measured with respect to isotactic polypropylene homopolymer. Preferably, heat of fusion is used to determine crystallinity. Thus, for example, assuming the heat of fusion for a highly crystalline polypropylene homopolymer is 190 J/g, a semi-crystalline propylene copolymer having a heat of fusion of 95 J/g will have a crystallinity of 50%. The term “crystallizable” as used herein refers to those polymers which can crystallize upon stretching or annealing. Thus, in certain specific embodiments, the semi-crystalline polymer may be crystallizable.

The semi-crystalline polymers used in specific embodiments of this invention preferably have a crystallinity of from 2% to 65% of the crystallinity of isotatic polypropylene. In further embodiments, the semi-crystalline polymers may have a crystallinity of from about 3% to about 40%, or from about 4% to about 30%, or from about 5% to about 25% of the crystallinity of isotactic polypropylene.

The semi-crystalline polymer of the polymer blend can have a level of isotacticity expressed as percentage of isotactic triads (three consecutive propylene units), as measured by ¹³C NMR, of 75 mol % or greater, 80 mol % or greater, 85 mol % or greater, 90 mol % or greater, 92 mol % or greater, 95 mol % or greater, or 97 mol % or greater. In one or more embodiments, the triad tacticity may range from about 75 mol % to about 99 mol %, or from about 80 mol % to about 99 mol %, or from about 85 mol % to about 99 mol %, or from about 90 mol % to about 99 mol %, or from about 90 mol % to about 97 mol %, or from about 80 mol % to about 97 mol %. Triad tacticity is determined by the methods described in U.S. Patent Application Publication No. 2004/0236042.

The semi-crystalline polymer of the polymer blend may have a tacticity index m/r ranging from a lower limit of 4, or 6 to an upper limit of 10, or 20, or 25. The tacticity index, expressed herein as “m/r”, is determined by ¹³C nuclear magnetic resonance (“NMR”). The tacticity index m/r is calculated as defined by H. N. Cheng in 17 MACROMOLECULES, 1950 (1984), incorporated herein by reference. The designation “m” or “r” describes the stereochemistry of pairs of contiguous propylene groups, “m” referring to meso and “r” to racemic. An m/r ratio of 1.0 generally describes an atactic polymer, and as the m/r ratio approaches zero, the polymer is increasingly more syndiotactic. The polymer is increasingly isotactic as the m/r ratio increases above 1.0 and approaches infinity.

In one or more embodiments, the semi-crystalline polymer of the polymer blend may have a density of from about 0.85 g/cm³ to about 0.92 g/cm³, or from about 0.86 g/cm³ to about 0.90 g/cm³, or from about 0.86 g/cm³ to about 0.89 g/cm³ at room temperature and determined according to ASTM D-792. As used herein, the term “room temperature” is used to refer to the temperature range of about 20° C. to about 23.5° C.

In one or more embodiments, the semi-crystalline polymer can have a weight average molecular weight (Mw) of from about 5,000 to about 500,000 g/mol, or from about 7,500 to about 300,000 g/mol, or from about 10,000 to about 200,000 g/mol, or from about 25,000 to about 175,000 g/mol.

Weight-average molecular weight, M_{w}, molecular weight distribution (MWD) or M_{w}/Mₙ where Mₙ is the number-average molecular weight, and the branching index, g′(vis), are characterized using a High Temperature Size Exclusion Chromatograph (SEC), equipped with a differential refractive index detector (DRI), an online light scattering detector (LS), and a viscometer. Experimental details not shown below, including how the detectors are calibrated, are described in: T. Sun, P. Brant, R.R. Chance, and W.W. Graessley, Macromolecules, Volume 34, Number 19, pp. 6812-6820, 2001. In one or more embodiments, the polymer blend can have a polydispersity index of from about 1.5 to about 6.

Solvent for the SEC experiment is prepared by dissolving 6 g of butylated hydroxy toluene as an antioxidant in 4 L of Aldrich reagent grade 1,2,4 trichlorobenzene (TCB). The TCB mixture is then filtered through a 0.7 μm glass pre-filter and subsequently through a 0.1 μm Teflon filter. The TCB is then degassed with an online degasser before entering the SEC. Polymer solutions are prepared by placing the dry polymer in a glass container, adding the desired amount of TCB, then heating the mixture at 160° C. with continuous agitation for about 2 hr. All quantities are measured gravimetrically. The TCB densities used to express the polymer concentration in mass/volume units are 1.463 g/mL at room temperature and 1.324 g/mL at 135° C. The injection concentration ranges from 1.0 to 2.0 mg/mL, with lower concentrations being used for higher molecular weight samples. Prior to running each sample the DRI detector and the injector are purged. Flow rate in the apparatus is then increased to 0.5 mL/min, and the DRI was allowed to stabilize for 8-9 hr before injecting the first sample. The LS laser is turned on 1 to 1.5 hr before running samples. As used herein, the term “room temperature” is used to refer to the temperature range of about 20° C. to about 23.5° C.

The concentration, c, at each point in the chromatogram is calculated from the baseline-subtracted DRI signal, I_{DRI}, using the following equation:

c=K_{DRI}I_{DRI}/(dn/dc)

where K_{DRI} is a constant determined by calibrating the DRI, and dn/dc is the same as described below for the LS analysis. Units on parameters throughout this description of the

SEC method are such that concentration is expressed in g/cm³, molecular weight is expressed in kg/mol, and intrinsic viscosity is expressed in dL/g.

The light scattering detector used is a Wyatt Technology High Temperature mini-DAWN. The polymer molecular weight, M, at each point in the chromatogram is determined by analyzing the LS output using the Zimm model for static light scattering (M. B. Huglin, LIGHT SCATTERING FROM POLYMER SOLUTIONS, Academic Press, 1971):

[Kₒc/ΔR(θ,c)]=[1/MP(θ)]+2A₂c

where ΔR(θ) is the measured excess Rayleigh scattering intensity at scattering angle θ, c is the polymer concentration determined from the DRI analysis, A₂ is the second virial coefficient, P(θ) is the form factor for a monodisperse random coil (described in the above reference), and Kₒ is the optical constant for the system:

$${K}_{o} = \frac{4 {π}^{2} {{n}^{2} ( d n / d c )}^{2}}{{λ}^{4} {N}_{A}}$$

in which N_{A} is the Avogadro's number, and dn/dc is the refractive index increment for the system. The refractive index, n=1.500 for TCB at 135° C. and λ=690 nm. In addition, A₂=0.0015 and dn/dc=0.104 for ethylene polymers, whereas A₂=0.0006 and dn/dc=0.104 for propylene polymers.

The molecular weight averages are usually defined by considering the discontinuous nature of the distribution in which the macromolecules exist in discrete fractions i containing Nᵢ molecules of molecular weight Mᵢ. The weight-average molecular weight, M_{w}, is defined as the sum of the products of the molecular weight Mᵢ of each fraction multiplied by its weight fraction wᵢ:

M_{w}≡ΣwᵢMᵢ=(ΣNᵢMᵢ²/ΣNᵢMᵢ)

since the weight fraction wᵢ is defined as the weight of molecules of molecular weight Mᵢ divided by the total weight of all the molecules present:

wᵢ=NᵢMᵢ/ΣNᵢMᵢ

The number-average molecular weight, Mₙ, is defined as the sum of the products of the molecular weight Mᵢ of each fraction multiplied by its mole fraction xᵢ:

Mₙ≡xᵢMᵢ=NᵢMᵢ/ΣNᵢ

since the mole fraction xᵢ is defined as Nᵢ divided by the total number of molecules:

xᵢ=Nᵢ/ΣNᵢ.

In the SEC, a high temperature Viscotek Corporation viscometer is used, which has four capillaries arranged in a Wheatstone bridge configuration with two pressure transducers. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])²

where c was determined from the DRI output.

The branching index (g′, also referred to as g′(vis)) is calculated using the output of the SEC-DRI-LS-VIS method as follows. The average intrinsic viscosity, [η]_{avg}, of the sample is calculated by:

$${[ η ]}_{avg} = \frac{{{Σc}_{i} [ η ]}_{i}}{{Σc}_{i}}$$

where the summations are over the chromatographic slices, i, between the integration limits.

The branching index g′ is defined as:

$${g}^{′} = \frac{{[ η ]}_{avg}}{k {M}_{v}^{α}}$$

where k=0.000579 and α=0.695 for ethylene polymers; k=0.0002288 and α=0.705 for propylene polymers; and k=0.00018 and α=0.7 for butene polymers.

Mᵥ is the viscosity-average molecular weight based on molecular weights determined by the LS analysis:

Mᵥ≡(ΣcᵢMᵢ^{α}/Σcᵢ)^{1/α}.

In one or more embodiments, the semi-crystalline polymer of the polymer blend may have a viscosity (also referred to a Brookfield viscosity or melt viscosity), measured at 190° C. and determined according to ASTM D-3236 from about 100 cP to about 500,000 cP, or from about 100 to about 100,000 cP, or from about 100 to about 50,000 cP, or from about 100 to about 25,000 cP, or from about 100 to about 15,000 cP, or from about 100 to about 10,000 cP, or from about 100 to about 5,000 cP, or from about 500 to about 15,000 cP, or from about 500 to about 10,000 cP, or from about 500 to about 5,000 cP, or from about 1,000 to about 10,000 cP, wherein 1 cP=1 mPa.sec.

The polymers that may be used in the adhesive compositions disclosed herein generally include any of the polymers according to the process disclosed in International Publication No. 2013/134038. The triad tacticity and tacticity index of a polymer may be controlled by the catalyst, which influences the stereoregularity of propylene placement, the polymerization temperature, according to which stereoregularity can be reduced by increasing the temperature, and by the type and amount of a comonomer, which tends to reduce the length of crystalline propylene derived sequences.

Adhesive compositions may be prepared by mechanically blending one or more polymer blends, described herein, with one or more tackifiers, waxes, antioxidants, oils, and any other suitable additives. It is appreciated that free flowing adhesive compositions disclosed herein can be used in a variety of applications, including but not limited to, packaging articles, nonwovens, and assembly.

### Additives

The HMA composition can include other adhesive components/additives, e.g., tackifiers, waxes, antioxidants, functionalized polyolefins, oils, and combinations thereof

The term “tackifier” is used herein to refer to an agent that allows the polymer of the composition to be more adhesive by improving wetting during the application. Tackifiers may be produced from petroleum-derived hydrocarbons and monomers of feedstock including tall oil and other polyterpene or resin sources. Tackifying agents are added to give tack to the adhesive and also to modify viscosity. Tack is required in most adhesive formulations to allow for proper joining of articles prior to the HMA solidifying. Useful commercial available tackifiers include the Escorez™ series, available from ExxonMobil Chemical, such as Escorez™ 5400.

The term “wax” is used herein to refer to a substance that tweaks the overall viscosity of the adhesive composition. The primary function of wax is to control the set time and cohesion of the adhesive system. Adhesive compositions of the present invention may comprise paraffin (petroleum) waxes and microcrystalline waxes. In embodiments, the adhesive compositions of the present invention may comprise no wax. In embodiments, waxes may be used with the polymer blends of the invention including, but not limited to, Castor Oil derivatives (HCO-waxes), ethylene co-terpolymers, Fisher-Tropsch waxes, microcrystalline, paraffin, polyolefin modified, and polyolefin. A useful commercially available wax is Polywax 2000, available from Baker Hughes.

The term “antioxidant” is used herein to refer to high molecular weight hindered phenols and multifunctional phenols. A useful commercially available antioxidant is Irganox™ 1010. Irganox 1010 is a hindered phenolic antioxidant available from BASF SE

Corporation located in Ludwigshafen, Germany. The invention is not limited to Irganox 1010 as the antioxidant. In embodiments, other antioxidants that may be used with the polymer blends of the invention, including, but are not limited to amines, hydroquinones, phenolics, phosphites, and thioester antioxidants.

The term “oil” or “plasticizer” is used herein to refer to a substance that improves the fluidity of a material. Useful commercial available plasticizers include Primol™ 352, a white oil available from ExxonMobil Chemical.

The term “functionalized polyolefin” is used herein to refer to maleic anhydride-modified polypropylene and maleic anhydride-modified polypropylene wax. A useful commercially available functionalized polyolefin is Honeywell AC™-596. AC-596 is polypropylene-maleic anhydride copolymer from Honeywell.

The term “polyolefin” is used herein to refer to ethylene vinyl acetate, ethylene acrylate, block copolymer, propylene homopolymer, ethylene homopolymer, propylene copolymer, ethylene copolymer, and amorphous poly-alpha olefin.

### EXAMPLES

In a pilot plant, propylene-ethylene copolymers are produced by reacting a feed stream of propylene with a feed stream of ethylene in the presence of a metallocene catalyst.

The polymer blends used in the examples of the present invention were produced in accordance with the method disclosed above and by the method generally described for preparing polyolefin adhesive components and compositions in WO Publication No. 2013/134038. Polymer Blend A has a viscosity at 190° C. of about 4,550 cP, a shore hardness C of about 16, and an ethylene content of about 12.3 wt %. Polymer Blend B has a viscosity at 190° C. of about 7,000 cP, a shore hardness C of about 18, and an ethylene content of about 12 wt %. Polymer Blend C has a viscosity at 190° C. of about 1200 cP, a shore hardness C of about 52, and an ethylene content of about 6.2 wt %.

Each polymer blend was mixed with antioxidant, tackifier, optionally a functionalized polyolefin component, optionally a wax, and optionally oil to form a hot melt adhesive composition, and fed into either a batch Z-blade mixer or an inventive continuous extruder.

Blending in the batch Z-blade mixer was performed as follows. The mixer was preheated to 160° C. Polymer blend was added, in small amounts, to the mixer. A portion of the tackifier was added to the mixer. A chronometer device was used to control the mixing cycle. After the polymer blend became molten, the remaining amount of tackifier was added to the mixer. Mixing was continued for 10 minutes. Wax, if present, was added to the mixer. Mixing was continued for 10 minutes. Any remaining components were added to the mixer. Mixing was continued, such that the total mixing time was 60 minutes.

Blending in the inventive continuous extruder was performed as follow. A Leistritz twin-screw rotating extruder, type LSM 34GL was used, with screw diameter D=34 mm, screw length L=1222.5 mm, L/D=36. The extruder had 10 barrel sections, 2 feel barrels, 1 vent barrel, with the length of each barrel was 110 mm, the screw speed was 8-390 rpm, and the normal feed rate was 5-30 kg/h.

HMA 1 has a blend of 69.7 wt % Polymer Blend A, 30 wt % Escorez 5400, and 0.3 wt % Irganox 1010. HMA 2 has a blend of 49.7 wt % Polymer Blend B, 40 wt % Escorez 5400, 10 wt % Primol 352, and 0.3 wt % Irganox 1010. HMA 3 has a blend of 73.7 wt % Polymer Blend C, 3.5 wt % AC 596, 14.5 wt % Escorez 5400, 8 wt % Polywax 2000, and 0.3 wt % Irganox 1010.

The temperature at each barrel section of the extruder of the hot melt adhesive compositions for the examples of the invention are reported in Table 1.The twin screw extruder used in the examples was electrically heated by individual barrel section heaters or cooled (e.g., Barrel Section 4 or 5) via a cooling system which circulated water at 20-50° C. through the barrel coring. For HMA 1 and 2, the polymer blend and antioxidant were added in Barrel Section 1, tackifier was added in Barrel Section 4, and oil was added in Barrel Section 8; the melt pressure was 11 bars (159.5 psi); the screw speed was 150 rpm. For HMA 3, all components were added in Barrel Section 1; the melt pressure was 4 bars (58.0 psi); the screw speed was 250 rpm.

TABLE 1

| Barrel Section | Measured (° C.) | | |
|---|---|---|---|
| Temperature Setting | HMA 1 | HMA 2 | HMA 3 |
| 1 | 130/130 | 130/130 | 130/129 |
| 2 | 130/129 | 130/129 | 160/158 |
| 3 | 130/130 | 130/130 | 160/160 |
| 4 | 20/55 | 20/55 | 160/160 |
| 5 | 110/128 | 110/128 | 20/not |
| | | | measured |
| 6 | 110/112 | 110/112 | 120/115 |
| 7 | 110/110 | 110/110 | 120/119 |
| 8 | 110/110 | 110/110 | 120/120 |
| 9 | 110/110 | 110/110 | 120/119 |
| 10 | 110/110 | 110/110 | 120/120 |

The melt viscosity of the hot melt adhesive composition for the examples of the invention is reported in Table 2.

TABLE 2

| | | | |
|---|---|---|---|
| Blend Temperature | HMA 1 | HMA 2 | HMA 3 |
| (° C.) | viscosity (cP) | viscosity (cP) | viscosity (cP) |

Blended using a Z-blade at 145° C. (comparative)

| | | | |
|---|---|---|---|
| 130 | 15,140 | 8,960 | 5,100 |
| 160 | 5,325 | 3,121 | 1,453 |
| 175 | 3,479 | 2,025 | 997 |

Blended using a continuous extruder (inventive)

| | | | |
|---|---|---|---|
| 130 | 15,080 | 9,175 | 5,987 |
| 160 | 5,233 | 3,208 | 1,468 |
| 175 | 3,421 | 2,102 | 1,002 |

As Table 2 indicates, HMAs produced using a continuous extruder according to the invention have similar viscosities as those produced using a conventional batch type extruder. The inventors appreciate that a degradation of HMA viscosity could negatively affect the cohesion of the HMA to a substrate and taint the color of the HMA. Accordingly, the continuous extruder of the invention affords the advantages over conventional batch extruders including reduction of productive costs, more automated processes, and reduced offline time, without compromising the resultant HMA product properties.

Certain embodiments and features have been described using a set of numerical upper limits and a set of numerical lower limits. It should be appreciated that ranges from any lower limit to any upper limit are contemplated unless otherwise indicated. Certain lower limits, upper limits, and ranges appear in one or more claims below. All numerical values are “about” or “approximately” the indicated value, and take into account experimental error and variations that would be expected by a person having ordinary skill in the art.

To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

We claim:

1. A method of preparing a hot melt adhesive composition, comprising the steps of:
(a) feeding a polymer blend into an extruder;
wherein the polymer blend comprises (a) a first propylene-based polymer, wherein the first propylene-based polymer is a homopolymer of propylene or a copolymer of propylene and ethylene or a C₄ to C₁₀ alpha-olefin; and (b) a second propylene-based polymer, wherein the second propylene-based polymer is a homopolymer of propylene or a copolymer of propylene and ethylene or a C₄ to C₁₀ alpha-olefin; wherein the second propylene-based polymer is different than the first propylene-based polymer and wherein the polymer blend has a melt viscosity of about 1,000 cP to about 30,000 cP at 190° C.;
(b) feeding one or more adhesive components into the extruder;
wherein the adhesive components is selected from at least one of a tackifier, wax, antioxidant, functionalized polyolefin, oil, plasticizers, and combinations thereof; and
(c) recovering an extrudate from the extruder, wherein the extrudate is a hot melt adhesive composition.

2. The method of claim 1, wherein the polymer blend and the one or more adhesive components are fed into the same extruder.

3. The method of claim 1, wherein the polymer blend and the one or more adhesive components are fed into different extruders.

4. The method of claim 1, wherein the one or more adhesive components further comprises a polyolefin, selected from at least one of ethylene vinyl acetate, ethylene acrylate, block copolymer, propylene homopolymer, ethylene homopolymer, propylene copolymer, ethylene copolymer, amorphous poly-alpha olefin, and combinations thereof.

5. The method of claim 1, wherein the extrudate is in the form of a pellet, prill, pillow, candle, stick, brick, and drum.

6. The method of claim 1, wherein the functionalized polyolefin, if present, is selected from the group consisting of a maleic anhydride-modified polypropylene and a maleic anhydride-modified polypropylene wax.

7. The method of claim 1, wherein the hot melt adhesive composition has a melt viscosity of less than about 100,000 cP at 175° C.

8. The method of claim 1, wherein the temperature of the extruder is from greater than about the melting point of the polymer blend to less than about 140° C.

9. The method of claim 1, wherein the one or more adhesive components has a melting point greater than that of the polymer blend, and the extruder temperature at the point of injection of the one or more adhesive components is higher than the extruder temperature at the point of injection of the polymer blend.

10. The method of claim 1, wherein the functionalized polyolefin, if present, may be fed into the extruder in molten form.

11. The method of claim 1, wherein the tackifier and wax, if present, can be fed into the extruder in liquid form.

12. The method of claim 1, wherein the one or more adhesive components has a melting point of equal to or greater than that of the polymer blend, the polymer blend and the one or more components are fed into the extruder together.

13. The method of claim 1, wherein the polymer blend has a Mw of about 10,000 to about 100,000 g/mol.

14. The method of claim 1, wherein the polymer blend has a melting point of about 35° C. to about 160° C.

15. The method of claim 1, wherein the polymer blend has a melting point of about 80° C. to about 140° C.

16. The method of claim 1, wherein the polymer blend and the one or more adhesive components are fed into the extruder together.

17. The method of claim 1, wherein the polymer blend and the one or more adhesive components are fed into the extruder at different times.

18. The method of claim 17, wherein the polymer blend and the one or more adhesive components are fed into the extruder in order of their viscosities from highest viscosity to lowest viscosity.

19. The method of claim 1, wherein the one or more adhesive components is fed as a solid or liquid into the extruder.

20. The method of claim 1, wherein the extruder is selected from a single screw and twin screw.

21. The method of claim 1, wherein the first propylene-based polymer comprises a copolymer of propylene and ethylene, and the second propylene-based polymer comprises a copolymer of propylene and ethylene.

22. The method of claim 1, wherein the polymer blend has a heat of fusion between about 10 J/g to about 90 J/g.

23. The method of claim 1, wherein the first propylene-based polymer and the second propylene-based propylene polymer have a difference in heat of fusion of at least 10 J/g.

24. The method of claim 1, wherein the polymer blend is present in the amount of about 40wt % to about 95wt % based on the hot melt adhesive composition.

25. An adhesive comprising the polymer blend made the method of claim 1.
